(19) United States
(12) Patent Application Publication
(10) Pub. No.: US 2010/0230943 A1
(43) Pub. Date: Sep. 16, 2010

(54) Inflator device for an airbag module

(75) Inventors: Stephen Kimmich, Obernburg (DE); Björn Windhausen, Goldbach (DE)

Correspondence Address: FOLEY AND LARDNER LLP;SUITE 500, 3000 K STREET NW, WASHINGTON, DC, 20007, US

(73) Assignee: TAKATA-PETRI AG

(21) Appl. No.: 12/659,953

(22) Filed: Mar. 25, 2010

Related U.S. Application Data
(63) Continuation of application No. PCT/EP2008/062836, filed on Sep. 25, 2008.

(30) Foreign Application Priority Data
Sep. 26, 2007 (DE) 10 2007 046 824.7

(51) Int. Cl. B60R 21/26

(52) U.S. Cl. 280/737

(57) ABSTRACT

An inflator device for an airbag module of a motor vehicle is provided. The inflator device comprising a combustion chamber for accommodating a gas charge from which as gas for inflating a gas bag can be generated, and a combustion chamber housing which surrounds an interior space of the combustion chamber, in which space the gas charge is housed. The combustion chamber housing is enclosed by a housing receptacle such that the combustion chamber housing can be supported on the housing receptacle in order to prevent a deformation or a break-up of the combustion chamber housing upon generation of gas according to its intended purposes in the combustion chamber. The housing receptacle is part of a module housing for receiving at least one gas bag of the airbag module.

### CROSS-REFERENCE TO RELATED PATENT APPLICATIONS

This application is a Continuation of International Application PCT/EP2008/062836, filed Sep. 25, 2008, which was published in German on Apr. 9, 2009 as WO 2009/043791 A1. The foregoing International Application is incorporated herein by reference in its entirety.

### BACKGROUND

The invention relates to an inflator device for an airbag module of a motor vehicle.

Such an inflator device comprises a combustion chamber for receiving of a gas charge out of which (by activating the inflator device by means of an igniter device intended for this purpose) a gas can be generated for inflating a gas bag of the airbag module, wherein the gas charge burns up (combustion of the gas charge); and which furthermore comprises a combustion chamber housing, which encloses the internal space of the combustion chamber, in which the gas charge is included.

It is known to use a gas generator for inflating of a gas bag of an airbag module in a motor vehicle, said gas bag forming a gas cushion in the inflated state for an to be protected occupant, whereby the gases which serve for inflating the gas bag are generated by burning up the gas charge in a combustion chamber of the gas generator and are subsequently guided out of the gas generator into the to be inflated gas bag. Due to the high pressure that results by generating the gas by burning up the gas charge in the combustion chamber, the housing walls of the combustion chamber housing which limit the combustion chamber have to be made sufficiently stable in order to be able to sustain the inner pressure acting in the combustion chamber. A higher weight of the gas generator as well as correspondingly higher material costs are connected herewith.

### SUMMARY

The problem underlying the invention is to improve an inflator device of the kind as mentioned at the beginning with respect to the design of the combustion chamber.

According to an exemplary embodiment of the invention the combustion chamber is carried out such that it cannot withstand the pressure that develops in the combustion chamber upon generation of gas according to its intended purpose by burning up the gas charge, and that the combustion chamber housing is closed by a housing receptacle such that it is supported on the housing receptacle in order to prevent a deformation or a break up of the combustion chamber housing upon generation of gas in the combustion chamber. Furthermore, the housing receptacle is part of the module housing for receiving at least one gas bag of the airbag module.

That the housing receptacle is part of the module housing has among others the advantage that no additional parts have to be used, which else wise have to be used for the connection of the combustion chamber housing to the airbag module. This leads to savings in material in comparison to conventional inflator devices. Losses of power of the inflator device when igniting the gas charge is reduced by an integration of the combustion chamber housing into the housing receptacle which is part of the module housing, in comparison to the case, in which the gas generator and the module housing need an external connection.

With that the design of the inflator device in accordance to the invention enables a correspondingly thin-walled design of the combustion chamber housing, for example with a wall thickness of less than 2 mm, in particular, with a wall thickness of less than 1 mm, without the combustion chamber housing being substantially deformed by the pressure which acts in the combustion chamber when the gases are generated or without the combustion chamber housing even be destroyed, since the combustion chamber is supported on the combustion chamber receiving.

The housing receptacle encloses the combustion chamber housing preferentially such that all parts of the combustion chamber housing which do not form (should not form) outlet openings for letting out gas of the combustion chamber, are lying on the housing receptacle and are supported by it. Such a support of the combustion chamber housing by the housing receptacle over the full area is not in all cases necessary; in some cases parts of the combustion housing are not supported on the housing receptacle, for example if the support of a part of the combustion chamber housing on the housing receptacle is sufficient for an overall stabilization of the combustion chamber housing such that it can withstand the inner pressure of the combustion chamber when hot gas is generated (which it could not if it was not supported on the housing receptacle).

A reception for the combustion chamber can be formed—for example in an area of the bottom of the housing—for the integration of the housing receptacle, which leads to the necessary stability of the combustion chamber, in a module housing of the airbag module, wherein the combustion chamber housing bears with its outer wall against said reception on which it can be supported. Such a housing receptacle can in the case of a front line—airbag module—be formed for example on the instrumental panel and in the case of a side airbag module on a door or roof paneling of the motor vehicle.

The combustion chamber housing can be formed out of metal, for example out of aluminum, steel, brass, copper, in each case advantageously in form of sheet or out of an alloy, wherein for the housing receptacle materials as for example synthetics or magnesium are suited.

The housing receptacle is in its geometry adjusted to the outer contour of the combustion chamber housing such, that the necessary support can be achieved. If the combustion chamber housing is tubular, in particular hollow-cylindrical, the usage of a housing receptacle is functional, which comprises a in its cross section ring-shaped circulating inner wall, which can bear against the outer wall of the combustion chamber housing.

A thin-walled design of the combustion chamber housing such that the combustion chamber can alone not withstand the inner pressure acting when a gas is generated, can furthermore be used to create outlet openings only when the gas is generated in the combustion chamber (by burning up the gas charge according to its intended purpose), through which the gas that has been generated in the combustion chamber can be set free to inflate a gas bag. In such a way defined, locally limited outlet openings of the combustion chamber housing can for example be formed by the combustion chamber housing being supported on the housing receptacle essentially with its full area, wherein those parts (outlet areas) of the combustion chamber housing are not supported, which shall form outlet openings upon generation of gas in the combustion chamber (by breaking up of the corresponding parts of the combustion chamber housing). This can in particularly for instance be realized by the housing receptacle having openings for the gas being generated in the combustion chamber, wherein those openings of the housing receptacle lead to outlet areas of the combustion chamber housing. These outlet areas of the combustion chamber housing are therefore characterized in that no material of the housing receptacle is subtended to them, on which they could support, but rather the face side of the opening of the housing receptacle. Hereby material of the combustion chamber housing can break up on these opening sections if correspondingly high inner pressures in the combustion chamber are realized by which the wanted outlet openings are created in the combustion chamber housing.

In such a way a combustion chamber can be provided, the combustion chamber housing of which is optionally together with further components, such as an igniter housing, at the beginning gas-tightly surrounding the combustion chamber.

Furthermore, it is practical for a design of the combustion chamber housing which is as simple as possible that a filtration device by means of which the gas that has been generated in the combustion chamber can be filtered is arranged outside of the combustion chamber, in particular spaced apart from the combustion chamber, for example at the housing receptacle, in particular on an outer side of the housing receptacle which is diverted from the combustion chamber, for example behind the outlet openings of the housing receptacle through which the gas that has been generated in the combustion chamber is guided into to be inflated gas bag.

The filter can be combined with a diffuser to form one building unit which is fixed by means of a suitable fixing device, for example in form of screws, on a corresponding component of the inflator device, especially on the housing receptacle, wherein the diffuser serves for a specific introduction of the gas that has been generated in the combustion chamber into the to be inflated gas bag.

Also a throttle device for regulating the burn up of the gas charge when the gas is generated can be advantageously arranged outside of the combustion chamber, for example on the housing receptacle, by designing the openings of the housing receptacle in its cross section specifically such that a predefined gas stream which controls the burn up in the combustion chamber out of the combustion chamber into the environment is possible.

A building unit separate from the combustion chamber can serve as the igniter device for activating the inflator device for causing the generation of a gas by burning up the gas charge provided in the combustion chamber, said separate building unit is connected in a suitable way with the combustion chamber, in particular with the combustion chamber housing, and is for example provided together with the combustion chamber housing in a common housing receptacle.

### BRIEF DESCRIPTION OF THE DRAWINGS

Further details and advantages of the invention will become clear in the following description of exemplary embodiments with Figures.

FIG. 1a shows a perspective exploded view of an inflator device arranged at a module housing for an airbag module of a motor vehicle.

FIG. 1b shows the arrangement of FIG. 1A in the assemble condition.

FIG. 2a shows a cut-through through the exploded view according to FIG. 1A.

FIG. 2b shows a cut-through through the view shown in FIG. 1B together with a gas bag which can be inflated by the inflator device.

FIG. 3a shows a prospective longitudinal section through the arrangement of FIG. 1B.

FIG. 3b shows a longitudinal section through the arrangement of FIG. 1B in side view.

FIG. 4 shows a modification of the exemplary embodiment shown in FIGS. 1A to 3B.

### DETAILED DESCRIPTION

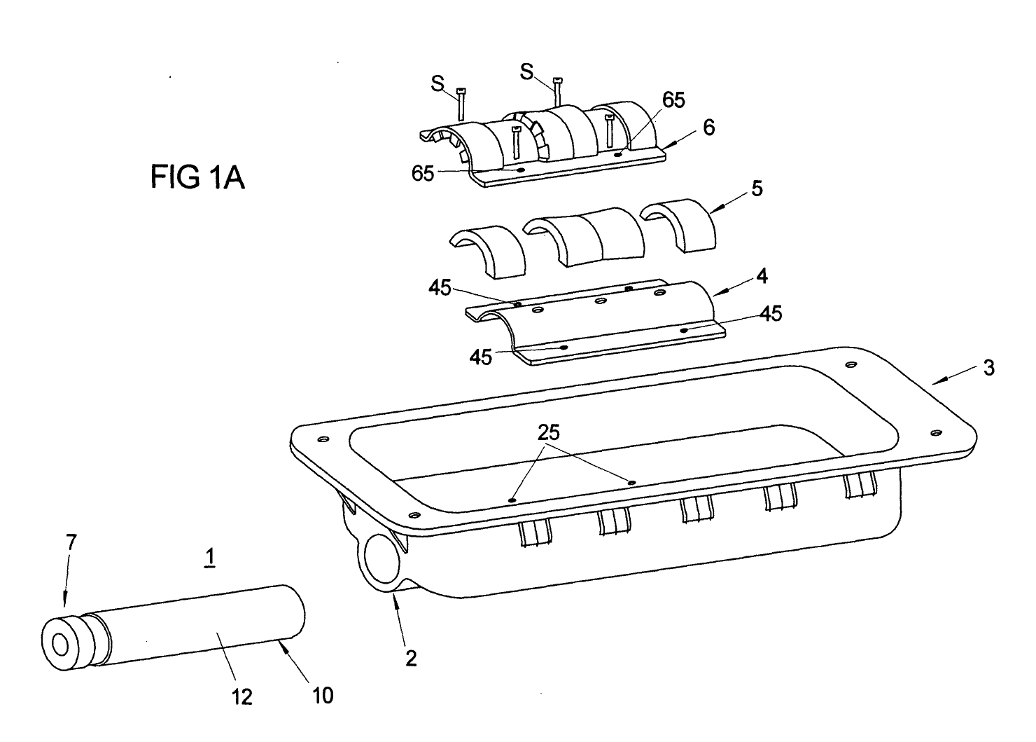

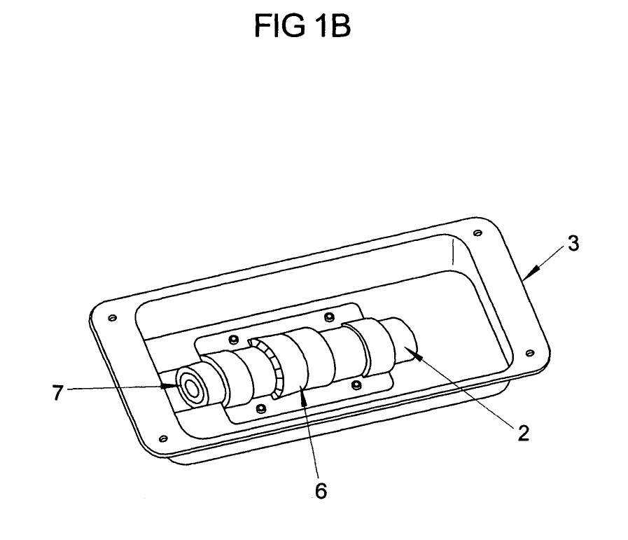

FIGS. 1a to 3b show an inflator device for inflating a gas bag of an airbag module which is arranged on a module housing 3 of an airbag module, such inflator device comprising as an essential component a combustion chamber 1, which comprises a tubular or rather hollow-cylindrical combustion chamber housing 10 which extends along a longitudinal axis A.

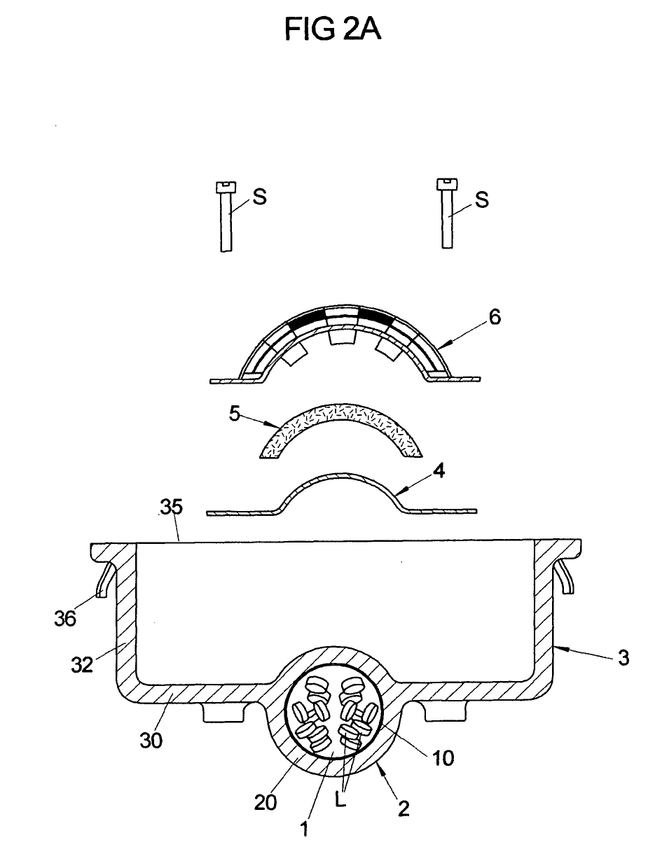

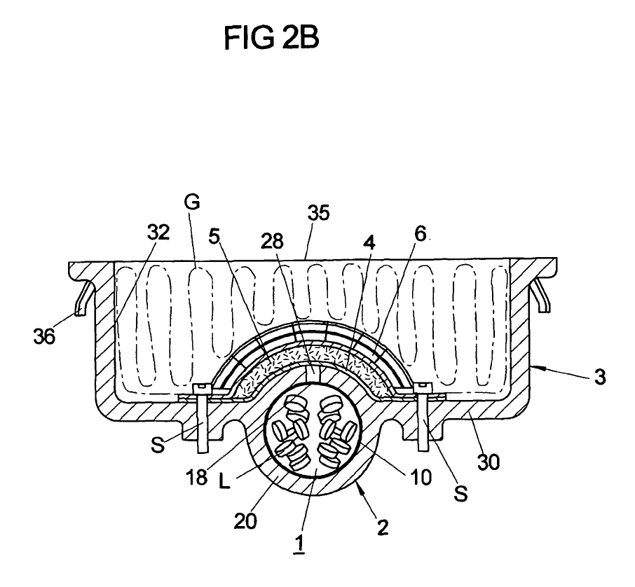

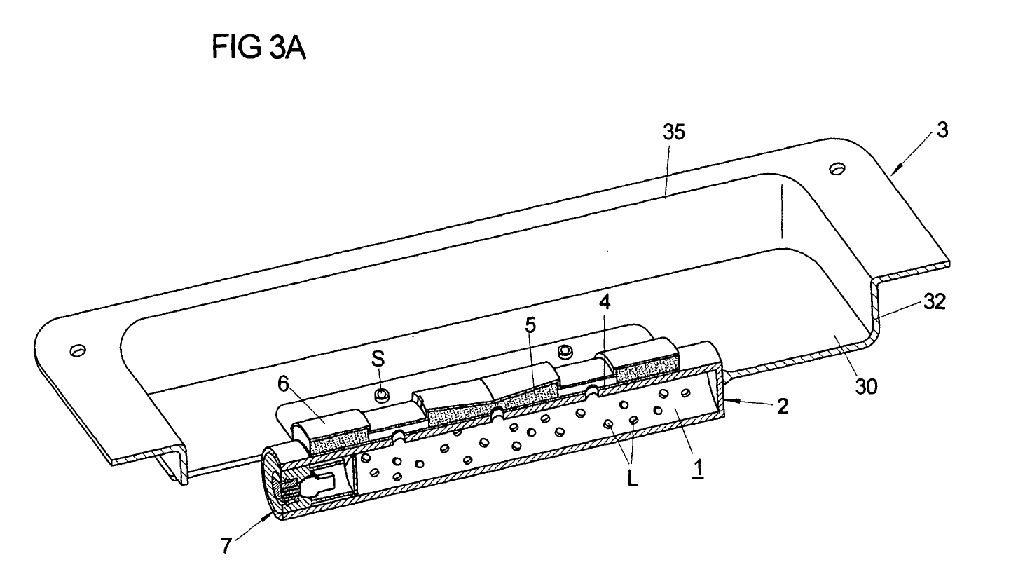

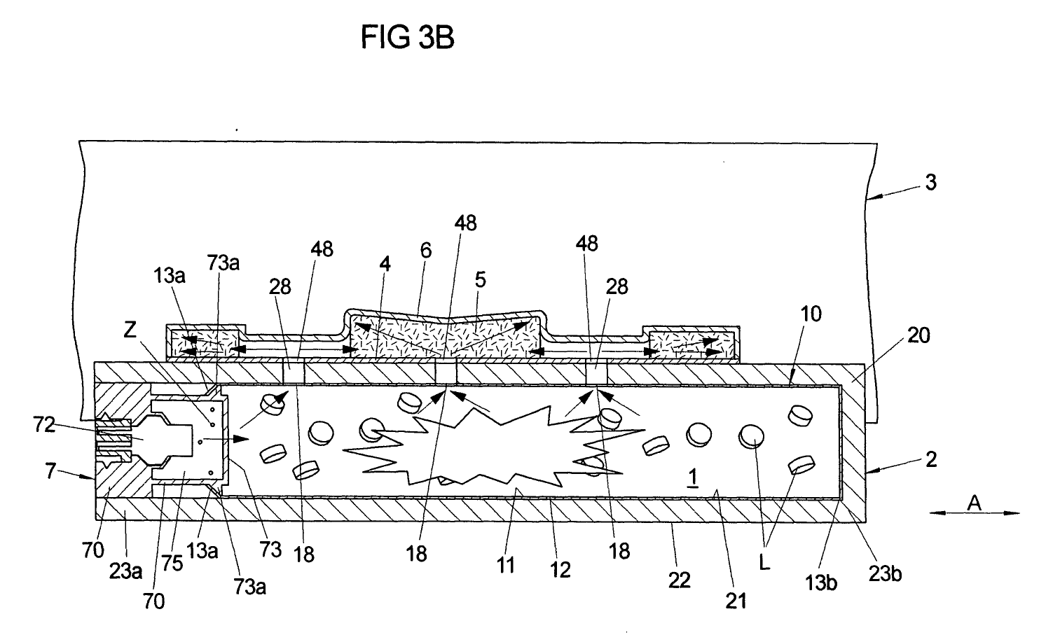

The combustion chamber housing 10 encloses an internal space, in which the gas charge in form of a solid charge L is arranged, out of which a gas for inflating a gas bag G which is indicated by lines and dots in FIG. 2b as a folded gas bag package of the airbag module can be generated. The folds or folding lines of the gas bag G are extending here exemplary in a longitudinal direction, that means perpendicular to the cross section plane of FIG. 2b; alternatively said folds can also extend parallel to the section plane of 2B and can extend perpendicular to the longitudinal section plane of FIG. 3b.

The combustion chamber housing 10 extends (in the direction of the axis of the pipe A) between the first front side A and the second front side B and comprises a coat with an inner surface 11 which faces the internal space and an outer surface 12 which is averted to the internal space of the combustion chamber housing. The wall thickness of the combustion chamber housing 10 that means the smallest difference between its inner surface 11 and its outer surface 12 is designed so small, that the combustion chamber housing 10 cannot withstand the inner pressure which is realized inside the combustion chamber 1 if a gas is generated by burning (burning up) of the gas charge which is arranged in the combustion chamber 1. For this a wall thickness of less than 2 mm, in particular less than 1 mm, is provided for a combustion chamber housing 10 which is made out of metal, in particular out of aluminum, steel, brass or copper plates or out of an alloy.

This means that the combustion chamber housing 1 taken alone would be destroyed by the gas pressure which is realized in combustion chamber 1 when the gas charge in form of a solid charge L is burned up and a (hot) gas is generated through this for inflating a gas bag, in particular by breaking up, in present exemplary embodiment. This is being prevented by the fact that the combustion chamber 1 is incorporated into its tubular housing 10 in a housing receptacle 2, said housing receptacle forming a one-piece part of a module housing 3 of the airbag module which consists of synthetics.

The module housing 3 comprises a floor space 30 and separated apart from it side walls 32 and forms a reception which is open on its upper side or top surface 35 for a gas bag of the airbag module which is folded to a gas bag package. The top surface 35 which is opposite to the floor space 30 of the module housing 3 is closed by a casing cover which is not shown in the Figures which can be blocked on the module housing 3 with locking elements 33, which protrude from the side walls 32.

A tubular housing receptacle 2 is integrally formed on the housing base 30 of the module housing 3, said housing receptacle 2 consists as the other areas of the module housing 3 out of synthetics and has a limiting wall 20 that runs around in an angular manner with an inner surface 21 which faces the combustion chamber housing 10 which is contained in the housing receptacle 2 and has an outer surface 22 which is averted to the combustion chamber housing 10.

The tubular or more precisely hollow cylindrical housing receptacle 2 extends as well as the combustion chamber 1 between a first front side 23a and a second front side 23b, wherein it is open on the first front side 23a for introducing the combustion chamber 1 and closed on the second front side 23b. the housing receptacle 2 is on its inner surface 21 which is oriented towards the combustion chamber 1 designed in such a manner that the combustion chamber 1 is with its outer surface 12 of the combustion chamber housing 10 in the area of its coat and in the area of the second front side 23b adjacent to the inner surface 21 of the housing receptacle 2 over a large area (essentially over the full area) and is supported thereon to the outer side. The combustion chamber 1 or the combustion chamber housing, respectively, is hereby saved from deformation and/or breakup under the action of a gas being generated in the combustion chamber 1.

An ignition device 7 for igniting the gas charge provided in the combustion chamber 1 in the form of a solid charge L is arranged in an area of the open first front side 23a of the housing receptacle 2. For this purpose the housing receptacle 2 is on its first front side 23a closed with an igniter housing 70, that on the one hand receives the igniter 72 of the igniter device 7 and on the other hand encloses an igniter chamber 75 which is optionally filled with an igniter compound Z. A front side 73 of the igniter housing 70 which faces the second front side 13a of the combustion chamber housing 10 serves for closing of the combustion chamber 1 on its first front side 13a, wherein fastening lugs of the combustion chamber housing 10 angled away from the first front side 13a of the combustion chamber housing 10 encompass corresponding fastening projections 73a of the igniter housing 70.

The igniter device 7 is a unit separate from the combustion chamber 1 or the combustion chamber housing 10, respectively, which is connected with the front side 73 of the igniter housing 70 with the combustion chamber 1 or the combustion chamber housing 10, respectively, via the mentioned fastening lugs on the first front side 13a of the combustion chamber housing 10 and via the corresponding fastening projections 73a of the igniter housing 70.

The fastening lugs need not be required, if the combustion chamber housing 10 has on its front 13a its own closure, for example in the form of a front side cap (which is sealingly connected to the combustion chamber housing 10, in particular crimped on the combustion chamber housing 10). It can be made in such a thin-walled manner (for example by using the materials for the combustion chamber housing mentioned above), that it is being punched through when the inflator device is activated, such that the gas charged provided in the combustion chamber 1 can be ignited.

In result the combustion chamber housing 10 surrounds together with above-mentioned face side 33 of the igniter housing 70 the internal space which contains the solid charge L gas-tightly and moisture proof. In particular there are no outlet openings from the start provided in the combustion chamber housing 10 in the exemplary embodiment shown in FIGS. 1a to 3b, through which gas that has been generated in the combustion chamber 1 for inflating a gas bag could escape.

However, the limiting wall 20 of the housing receptacle 2 is provided with several through openings 28, through which as leaving the combustion chamber 1 can stream into a to be inflated gas bag which is arranged in a module housing 3. These through openings extend from the inner surface 21 facing the combustion chamber 1 to the outer surface 22 of the housing receptacle 2 which is averted to the combustion chamber 1 and point their outer surface 22 into the interior of the module housing 3, where the to be inflated gas bag is arranged.

Since the combustion chamber housing 10 is not supported by the housing receptacle 2 in those parts (outlet regions) on which the outlet openings 28 of the housing receptacle 2 border, the combustion chamber housing 10 bursts in those parts which are adjacent to the through openings 28 (outlet areas), if the inner pressure of the combustion chamber 1 exceeds a particular value when burning up of a gas charge in form of a solid charge L and the herewith generation of a gas. Through this the outlet openings 18 are being created in the combustion chamber housing 10 that align with the through openings 28 on the side of the housing receptacle. Thus, gas generated in the combustion chamber can be led through the outlet openings 18 which are only formed when the gas is generated and flows through the through openings 28 of the housing receptacle which lie in the direction of the gas flow behind into the interior of the module housing 3, where the gas can be used to inflate the gas bag which is arranged there.

However, the gases do not stream directly into the gas bag when they leave the through openings 28 of the housing receptacle 2, but are led firstly through a heat shield filter diffuser assembly, which comprises the heat shield 4, a filter 5 and a diffuser 6.

The heat shield 4 lies in a region of the trough openings 28 directly at the outer surface 20 of the housing receptacle and comprises through openings 48 which are in line with the through openings 28 and cover those. A unit consisting of a diffuser and a filter arranged in the diffuser is provided in the direction of the gas flow behind the heat shield 4, said unit serving for the filtering of the gas being generated in the combustion chamber 1 and for the targeted inducing of the gas into the to be inflated gas bag.

Suitable diffuser types with which gas that has been set free out of a gas generator can be led into a to be inflated gas bag are known. A specialty is that the filtering assembly 5 which serves for filtering of the gas is not provided in the combustion chamber 1 but outside of the combustion chamber and is integrated with the diffuser 6 to form one unit.

The heat shield 4 and the diffuser 6 comprise each one a mounting flange with mounting openings 45 and 65 by which the heat shield 4 and the diffuser 6 —together with the filtering assembly 5 which is arranged between the heat shield 4 and the diffuser 6 can by suitable mounting devices, for example in the form of screws S, mounted in the inner of the module housing on its housing base 30 and therefore also on the housing receptacle 2.

In result the heat shield 4, the filtering assembly 5 and the diffuser 6 are each provided outside of the combustion chamber 1 and separated from the combustion chamber housing 10 behind an outer surface 22 of the housing receptacle 2 and are integrated into one unit, which is fixed by common mounting means S on the module housing 3, in particular on the base of the module housing 30.

The igniter device 7 is electrically activated in a known manner for activating the inflator device shown in FIGS. 1a to 3b, that means to generate therewith a gas, with which a gas bag which is arranged in the module housing 3 and which is carpeted to a gas packet can be inflated, wherein the electric activation of the igniter device 7 can for example be induced by a crash or pre-crash sensor. The gas charge provided inside of the combustion chamber 1 in the form of a solid charge L is ignited by means of the igniter device 7 such that it burns off and generates a gas in the combustion chamber 1 which is tightly closed by means of the combustion chamber housing 10 and of face side 73 of the igniter housing 70. The gas pressure (inner pressure) that is created herewith finally is so big that the thin-walled combustion chamber housing 10 cannot withstand it and would be substantially deformed under the action of the inner pressure or would even break up in the present exemplary embodiment. However, this is prevented by the combustion chamber housing 10 being located in a housing receptacle 2 which is (integrally) formed in a module housing 3, on which the combustion chamber housing 10 is supported.

The combustion chamber housing 10 only bursts adjacent to through openings 28 of the housing receptacle 2 in smaller partial areas (outlet areas), such that the outlet openings 18 are formed, which cover the through openings 28 of the housing receptacle 2. In this way the gas generated in the combustion chamber 1 can come through the outlet openings 18 on the side of the combustion chamber and through the through openings 28 on the side of the housing receptacle as well as through the through openings of a heat shield 4 which is arranged behind, through the filter assembly 5 and through the diffuser 6 into the to be inflated gas bag.

The through openings 28 of the housing receptacle 2 serve at the same time as a throttle device (which is arranged outside of the combustion chamber 1) for controlling the burning up in the combustion chamber 1 and therefore for controlling the power of the whole system. The smallest cross section of the corresponding through opening 28 is here important.

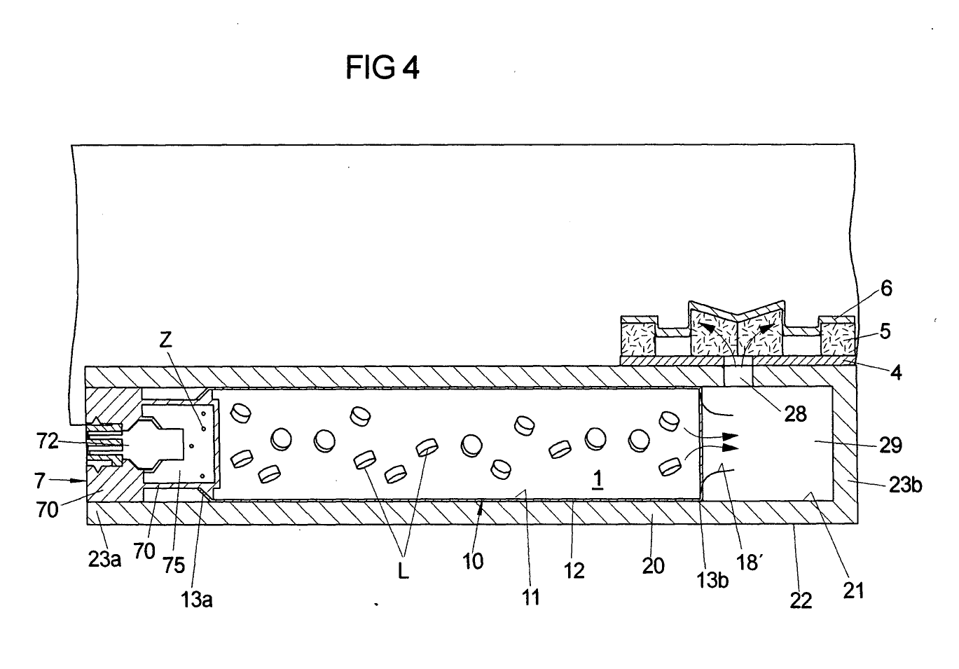

A variation of the arrangement from the FIGS. 1a to 3b is depicted in FIG. 4, in which at least one outlet opening 18′ which forms in the combustion chamber housing 10 (under the gas pressure) is not—as in the case of the FIGS. 1a to 3b provided in the lateral surface of the combustion chamber housing 10, but is rather provided on the front side 13b of the combustion chamber housing 10 such that the gas which is generated in the combustion chamber 1 can leave along the pipe A defined by the combustion chamber 1.

While the outlet openings 18 of the combustion chamber housing 10 are each formed on its outer surface in the exemplary embodiments discussed before such that the gases can leave out of those outlet openings 18 each in radial direction relative to the pipe axis A which is defined by the combustion chamber housing 10, at least one outlet opening 18′ is in the case of the exemplary embodiment shown in FIG. 4 arranged such on a front side of the combustion chamber housing 10, that gases which have been generated in the combustion chamber 1 can leave through the outlet opening 18 in axial direction (along the pipe axis A). Then they reach a chamber 24 which is provided on a front side 23b of the housing receptacle 2 out of which they can stream through at least one through opening 28 on the side of the housing receptacle (in radial direction) into a to be inflated gas bag and again over a heat shield 4, a filter 5 and a diffuser 6. Said chamber 24 lies adjacent to the front side 30b of the combustion chamber housing 10, in which at least one outlet opening 18′ on the side of the combustion chamber housing is formed because of the gas pressure of gases which have been generated in the combustion chamber 1.

Summarizing, the inflation devices which have been described earlier with FIGS. 1a to 4 comprise each a tubular (cylindrical) combustion chamber with a pyrotechnical gas charge, which is enclosed by a thin walled combustion chamber housing, for example consisting out of metal, such that in particular an internal space which is sealed against dirt and moisture for receiving the pyrotechnical gas charge is formed. Neither a filter assembly nor a throttle device for controlling the burn up of the gas charge have to be provided in the combustion chamber itself. Furthermore, a separate igniter device is assigned to the combustion chamber.

The combustion chamber housing cannot withstand the inner pressure in the combustion chamber because of its thin-walled design, which appears when the pyrotechnical gas charge is burned up and the herewith connected generation of gas appears. A destruction of the combustion chamber housing by the inner pressure which appears when the gas is generated in the combustion chamber is avoided by the fact that the combustion chamber is together with a corresponding igniter assembly inserted into a module housing which is formed on the housing receptacle, on which the combustion chamber lies against and is supported.

Therefore, the combustion chamber housing bursts when the pyrotechnical gas charge for generating the gas is burned up only in those specified parts (outlet areas) on which the through openings on the side of the housing receptacle for the gas that has been generated in the combustion chamber border, which overlap with the outlet openings on the housing receptacle side. The through openings on the housing receptacle side or in particular their smallest cross section form a throttle device for controlling the burn up in the combustion chamber and therefore for controlling the power of the whole system.

After the gases that have been generated in the combustion chamber have left through the outlet openings on the combustion chamber side and the through openings on the housing receptacle side in the direction of the to be inflated gas bag, they stream through a filter device, which is arranged outside of the combustion chamber housing on a housing receptacle and that is on the outer side of the housing receptacle which is averted to the combustion chamber. This filter can be designed with respect to its geometry symmetrical or asymmetrical and can be designed undirected, wherein the geometry of the filter device can in particular be adjusted to the housing receptacle. Expanded metal, a wire mesh and such are for example suited for forming a filter device.

The filter is combined with a diffuser to form a unit, which is provided for purposefully introducing set-free gas out of a combustion chamber into a to be inflated gas bag and is fixed on the module housing and with this on the housing receptacle which is formed thereon by a suited mounting means, for example in the form of screws, which consists out of metal or synthetic material, wherein the mounting of the diffuser and the filter device on the module housing can serve at the same time to fix by clamping the to be inflated gas bag G, compare FIG. 2a.

The unit consisting out of the filter device and the diffuser can be extended if needed by a heat shield, which for example is arranged between the housing receptacle and said unit, for providing protection from the heat connected with the out-streaming hot gas.

The priority application, German Application No. 10 2007 046 824.7, filed Sep. 26, 2007, including the specification, drawings, claims and abstract, is incorporated herein by reference in its entirety.

What is claimed is:

1. An inflator device for an airbag module of a motor vehicle with
a combustion chamber for receiving a gas charge, from which a gas for inflating a gasbag can be generated, and
a combustion chamber housing, which encloses an internal space of the combustion chamber, in which the gas charge is housed,
wherein the combustion chamber housing is designed such, that it cannot withstand the pressure that develops in the combustion chamber upon generation of gas according to its intended purpose, and that the combustion chamber housing is enclosed by a housing receptacle such, that the combustion chamber housing can be supported on the housing receptacle in order to prevent a deformation or a break-up of the combustion chamber housing upon generation of gas in the combustion chamber according to its intended purpose and that the housing receptacle is part of a module housing for receiving at least one gas bag of the airbag module and wherein the housing receptacle is formed on the module housing in one-piece.

2. The inflator device according to claim 1, wherein the combustion chamber housing is designed so thin-walled that it cannot withstand the pressure that develops in the combustion chamber upon generation of gas according to its intended purpose.

3. The inflator device according to claim 1, wherein the combustion chamber housing encloses the internal space of the combustion chamber in gas-tight manner.

4. The inflator device according to claim 3, wherein the combustion chamber housing encloses the internal space of the combustion chamber together with a igniter housing of an igniter device in a gas tightly manner.

5. The inflator device according to claim 1, wherein the combustion chamber comprises at least one outlet area in order to may let out generated in the combustion chamber from the combustion chamber.

6. The inflator device according to claim 1, wherein at least one outlet opening is formed in an outlet area of the combustion chamber housing under the influence of the gas pressure that develops in the combustion chamber, upon generation of gas in the combustion chamber according to its intended purpose.

7. The inflator device according to claim 6, wherein the at least one outlet opening is formed by a locally limited break-up of the combustion chamber housing under the influence of the pressure that develops in the combustion chamber upon generation of gas in the combustion chamber according to its intended purpose.

8. The inflator device according to claim 7, wherein the at least one outlet opening is intentionally formed at an outlet area of the combustion chamber housing which is not supported on the housing receptacle.

9. The inflator device according to claim 1, wherein the housing receptacle has at least one through opening through which gas that has been generated in the combustion chamber can pass into a gas bag to be inflated.

10. The inflator device according to claim 7, wherein the at least one outlet opening is formed by a locally limited break-up of the combustion chamber housing in a outlet area which adjoins a through opening of the housing receptacle.

11. The inflator device according to claim 1, wherein the housing receptacle is part of a motor vehicle body or interior lining of a motor vehicle, in particular of an instrument panel or an interior lining of a door.

12. The inflator device according to claim 1, wherein a filter device for filtering the gas generated in the combustion chamber is provided outside the combustion chamber.

13. The inflator device according to claims 12, wherein the filter device is combined with a diffuser to form a unit, wherein the diffuser serves for introducing the gas that is generated in the combustion chamber into a gas bag to inflated.

14. The Inflator device according to claim 1, wherein a throttle device is provided outside the combustion chamber for controlling the combustion of the gas charge upon generation of gas according to its intended purposes.

15. The inflator device according to claim 14, wherein the throttle device is provided at the housing receptacle.

16. The inflator device according to claim 1, wherein a igniter device, which forms a unit separate from the combustion chamber, for igniting a gas charge provided in the combustion chamber is assigned to the combustion chamber.

17. The inflator device according to claim 16, wherein the igniter device is connected to the combustion chamber housing.

18. The inflator device according to claim 17, wherein the igniter device is arranged together with the combustion chamber in the housing receptacle.

19. The inflator device according to claim 1, wherein the combustion chamber housing is supported over a large area on the housing receptacle upon generation of a gas according to its intended purpose.

20. The inflator device according to 6, wherein the combustion chamber housing is not support in merely such portions, on which outlet openings of the combustion chamber shall be formed under the influence of a gas generated in the combustion chamber according to its intended purpose.
